(19) United States
(12) Patent Application Publication
(10) Pub. No.: US 2004/0054874 A1
(43) Pub. Date: Mar. 18, 2004

(54) Data processing device with a spare field in the instruction

(76) Inventors: Takehiro Shimizu, Hachioji (JP); Fumio Arakawa, Kodaira (JP)

Correspondence Address: Mattingly, Stranger & Malur, P.C., Suite 370, 1800 Diagonal Road, Alexandria, VA, 22314, US

(21) Appl. No.: 10/612,934

(22) Filed: Jul. 7, 2003

(30) Foreign Application Priority Data
Sep. 17, 2002 (JP) P2002-269754

(51) Int. Cl. G06F 9/30

(52) U.S. Cl. 712/213

(57) ABSTRACT

A data processing device capable of high speed operation and shorter instruction processing time without causing software compatibility problems. When storing an instruction from the memory into the instruction cache memory and the instruction possesses a spare field, the instruction code of that instruction is predecoded in the predecode-processor and the information generated is stored in the spare field corresponding area of the instruction cache memory. When that instruction is fetched from the instruction cache memory, the information stored in the spare field corresponding area of the instruction cache memory is utilized. In this way, processing can proceed based on the predecoded information without having to await the completion of decoding of the instruction fetched from the instruction cache memory.

### BACKGROUND OF THE INVENTION

1. Field of the Invention

The present invention relates to a data processing device for executing instructions and relates to technology effective for data processors having instruction sets with a spare field left in the instruction for example for future expansion of the instruction set.

2. Description of Related Art

Reference is made to the following:

[Patent document 1]

JP-A No. 142694-2001

[Patent document 2]

JP-A No. 029684-2000 (U.S. Pat. No. 6,105,126)

[Patent document 3]

JP-A No. 029685-2000(U.S. Pat. No. 6,085,313)

A technology for implementing an address extension by utilizing the reserve bit in the spare field of the instruction is described in patent document 1. A technology for establishing an expansion section for the operation code and expanding the instruction format is described in patent documents 2 and 3.

In recent years, to make processors operate at higher speeds, the pipeline stage is usually finely divided into individual stages and the logic steps in each of these stages are reduced to improve (raise) the operating frequency. To achieve microprocessor for personal computers with a frequency higher than 1 gigahertz (GHz), a microarchitecture (super pipeline method) may for example be defined having a pipeline stage made up of dozens of stages. However, when the number of pipeline stages are increased and a branching prediction error occurs during branching, an extremely large penalty accompanies this error.

The inventors studied how to reduce this kind of penalty. Speeding up the decoding and execution of instructions for example for branch instructions is effective in reducing these kinds of penalties. This speedup can also be achieved by adding new instructions, and by renewing the instruction set however problems occur. It is because, there is a strong need to keep using the existing software even if the computer hardware has become more advanced and so upward compatibility is required.

However, in the technology of patent document 1, the address expandability is limited by the previously allotted values and speeding up the decoding and execution of instructions by any other function expansion is impossible. The technology of patent document 1 moreover describes no method for storing information in the spare field by using hardware so that the compiler and assembler must be modified and an instruction set with an expanded spare field must be established using the software. Patent documents 2 and 3 are both the same in this respect.

### SUMMARY OF THE INVENTION

The present invention therefore has the object of providing a data processor device capable of high speed operation and shorter instruction processing time without causing software compatibility problems.

These objects and further objects and novel features of the present invention will become clear to one skilled in the art from the following description and accompanying drawings.

Typical aspects among aspects disclosed in the present application are described as follows.

[1] When storing an instruction from the memory into the instruction cache memory and the instruction possesses a spare field, the instruction code of that instruction is predecoded and the information generated is stored in the spare field corresponding area of the instruction cache memory (area corresponding to the spare field of the instruction). When that instruction is fetched from the instruction cache memory, the information stored in the spare field corresponding area of the instruction cache memory is utilized. The processing can in this way proceed based on the predecoded information without having to await the completion of decoding of the instruction fetched from the instruction cache memory. The decoding and execution of the instruction can therefore be accelerated.

One specific aspect of the present invention is means for using information stored in the corresponding spare field area when for example executing an instruction loaded from the cache memory. This means is a control means capable of controlling the procedure for executing instructions based on information in the region corresponding to the spare field of the applicable instruction.

Another specific aspect of the present invention comprises a predecoder for predecoding (information) when storing instructions in the instruction cache memory.

The predecoder decodes the operation code contained in a first field of the instruction.

Information on the type of instruction for example is stored in the corresponding spare field area as decode results from operation decoding. This information may for example be information showing whether the instruction type is branch instruction or not.

When the control means determines that information on the area corresponding to the specified field of the instruction loaded from the instruction cache memory is the applicable branch memory, then a command is given for example to fetch the branch destination command.

The control means at this time is for the split-branch method. More specifically, a control means for the split-branch method possesses a queuing buffer to temporarily hold the instruction loaded from the instruction cache memory, possesses an instruction set holding a pre-branch processing instruction and branch processing instruction for dividing up one branching operation, (this pre-branch processing instruction is for commanding calculation of the branch destination address and fetching of the branch destination instruction) and possesses a target buffer for temporarily holding a branch destination instruction and branch destination address acquired from executing the branch destination processing instruction. When the control means had determined that the instruction is a branch processing instruction by means of information for the area corresponding to the specified field of the instruction held in the queuing buffer; then the control means issues instructions to load the branch instruction and the subsequent branch destination address from the target buffer.

Another specific aspect of the present invention comprises a processor for processing using information contained in the second field of the applicable instruction when storing instructions in the instruction cache memory. Based on decoding results from the predecoder, an area on the instruction cache memory corresponding to the second field of the instruction holds the processing results from the processor at this time.

To handle a relative branch instruction for a program counter with n bit displacement, the processor may for example, add n bits of lower address information of the program counter to the second field displacement; hold the n bit addition results in an area of the cache memory corresponding to the second field of the branch instruction program counter with displacement; and hold the carry information from the addition in an area corresponding to the spare field of the branch instruction program counter with displacement.

[2] Even if the instruction does not have a spare field, the instruction cache memory can still store the generated information each paired with an instruction into an area of the cache memory based on the predecoded instruction. In this case also, processing can continue based on the predecoded information without awaiting the end of decoding of the instruction fetched from the instruction cache memory. The decoding and execution of instructions can therefore be performed at high speed.

### BRIEF DESCRIPTION OF THE DRAWINGS

FIG. 1 is a block diagram showing the data processor of the embodiment of the present invention;

FIG. 2 is a descriptive view showing a first aspect of the principle of function expansion by predecoding of the instruction;

FIG. 3 is a descriptive view showing in principle a second aspect of function expansion by predecoding of the instruction;

FIG. 4 is a drawing of an instruction format showing an instruction having a spare field;

FIG. 5 is a drawing of an instruction format showing an instruction having a spare field and a displacement field;

FIG. 6 is a block diagram showing a predecoder-processor;

FIG. 7 is a block diagram showing a fetch-branch unit;

FIG. 8 is block diagram showing instruction queue;

FIG. 9 is a timing chart showing the operation timing for an early instruction decision circuit using the split-branch method; and

FIG. 10 is a block diagram showing instruction cache memory use during instructions when there is no spare field.

### DETAILED DESCRIPTION OF THE PREFERRED EMBODIMENTS

(Data Processor)

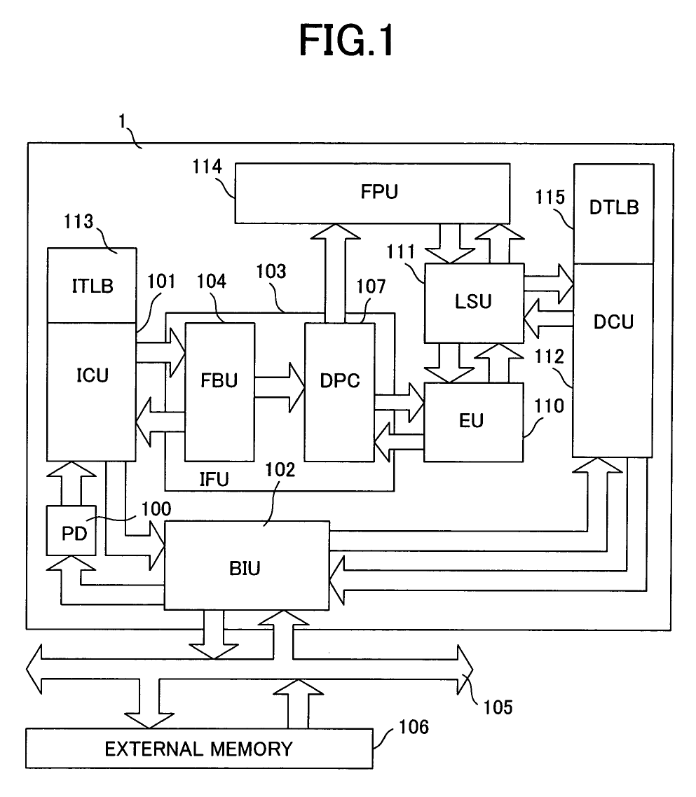

FIG. 1 shows a data processor of the present invention. A data processor 1 is comprised of a bus interface unit (BIU) 102 for inputting and outputting data to and from an external memory and peripheral circuits, an instruction cache memory (ICU) 101, an instruction address translation buffer (ITLB) 113, a data cache memory (DCU) 112, a data address conversion buffer (DTLB) 115, an instruction flow unit (IFU) 103 for processing such as instruction fetch—decode—execute schedule, an execute unit (EU) 110, a floating decimal point processor unit (FPU) 114, a load store unit (LSU) 111, and a predecode-processor (PD) 100. The data processor 1 executes instructions by the pipeline method and for example, executes processing in pipeline stages such as instruction fetch, decode, execution, and write-back, etc. The instruction flow unit (IFU) 103 controls scheduling for executing the pipeline stage (processes).

There are no particular restrictions on the instruction cache memory 101, instruction address translation buffer (ITLB) 113, a data cache memory (DCU) 112, a data address conversion buffer (DTLB) 115 however these are respectively comprised of associative-type linked memories. There are no particular restrictions on the instruction cache memory (ICU) 101 and data cache memory 112 however these constitute logic caches. The logic address and actual address contained in the instruction address translation buffer (ITLB) 113 and data address translation (DTLB) buffer 115 are utilized for conversion to the actual address required to replace a cache entry.

The execute unit (EU) 110 contains a general-purpose register, a program counter (PC) and an arithmetic logic unit (ALU), etc. The execute unit (EU) 110 executes the various processing based on control signals generated in the instruction flow unit.

The bus interface unit (BIU) 102 is connected to the external bus 105. An external memory 106 is shown connected to the external bus 105. The external memory 106 here constitutes the main memory, and is utilized for the program memory and work area, etc. Though not shown in the drawing, the data processor 1 contains a peripheral circuit connected to the bus interface unit (BIU) 102.

The predecode-processor (PD) 100 is installed between the bus interface unit (BIU) 102 and the instruction cache memory (ICU) 101. When an instruction is loaded to the instruction cache memory (ICU) 101 from the external memory 106, that instruction supplied from the bus interface unit (BIU) 102 is predecoded and the specified processing, for example branch destination address processing is performed. Based on information generated for example from predecoding of that instruction, the instruction cache memory (ICU) 101 holds the instruction results and address processing results for example from the predecoding in a specified field for the applicable instruction such as an area corresponding a spare field or address conversion displacement field.

When the instruction loaded from the instruction cache memory 101 is executed, the instruction flow unit (IFU) 103 can control the instruction execution procedure based on information in the area corresponding to the spare field of the applicable instruction and the displacement field for address processing. The instruction flow unit (IFU) 103 can in this way proceed with processing based on the predecoded information without having to wait for completion of decoding of the instruction fetched from the instruction cache memory 101 and the decoding and execution of the instruction can be accelerated. Since the information stored in the instruction cache memory 101, which was generated from predecoding could be used for upcoming decoding stages, they can be linked with functions for speeding up the identifying of instructions and reducing the processing load during execution of instructions.

<First Aspect of Function Expansion>

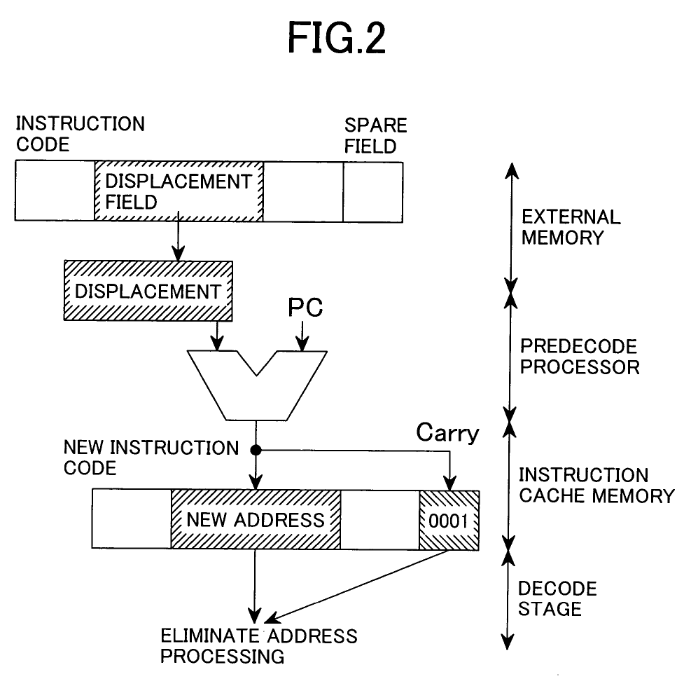

A first aspect of function expansion by predecoding of the instruction is shown in FIG. 2. The instruction shown here is for example, a PC branch instruction. This instruction contains a displacement field and a spare field. Lower-ranked PC information is added to the displacement. The results of that addition are matched to the displacement field and the carry matched to the spare field and are stored in the memory storage area of the applicable instruction on the instruction cache memory. Processing of the branch address does not have to be performed from the start, in the decoding stage.

<Second Aspect of Function Expansion>

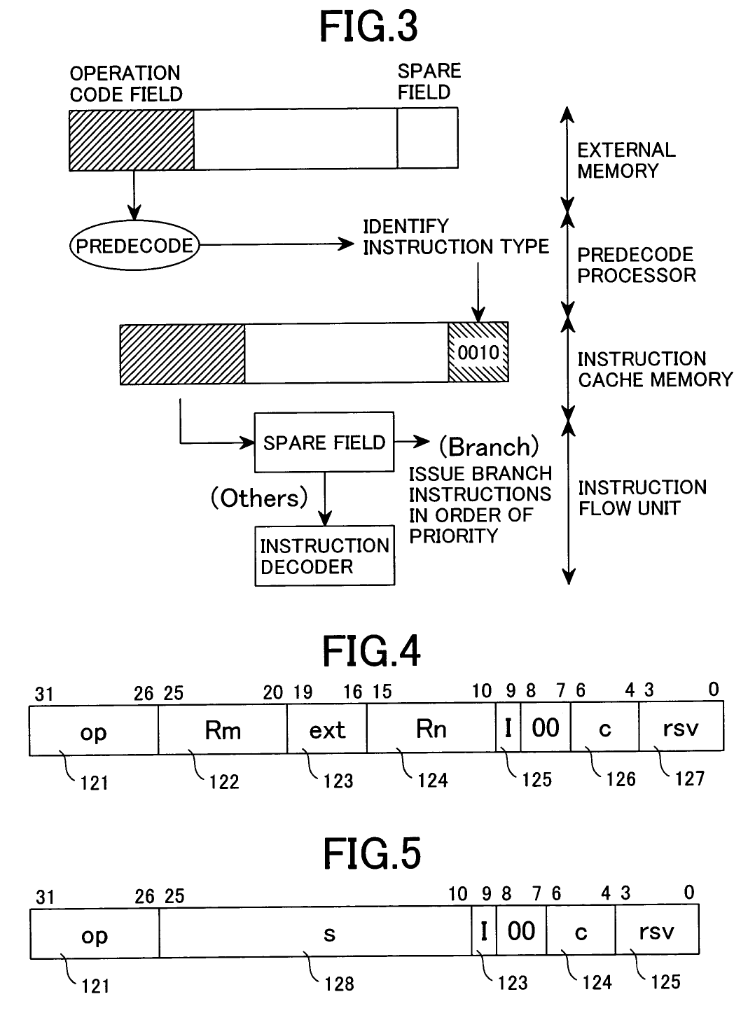

A second aspect of function expansion by predecoding of the instruction is shown in FIG. 3. The instruction shown here is a branch instruction. This instruction contains an operation code field and a spare field. The operation code is predecoded and the information corresponding to the type of instruction such as information showing whether it is a branch instruction is matched to the spare field and stored in the memory area of the applicable instruction on the instruction cache memory. In the decode stage, information in the area corresponding to the spare field is determined during a branch instruction and an instruction fetch from the branch destination address is commanded. When not a branch command, decoding for example of an operation code by the instruction decoder is commanded. The command for branch destination instruction fetch can therefore be started without waiting for decoding of the operation code to be completed.

<Generation of Function Expansion Based on Predecoding>

The first and second aspects of function expansion by predecoding are next explained in detail. A branch instruction having fields as shown in FIG. 4 and FIG. 5 is used as an example. The instruction shown in the figure is a 32 bit length RISC processor instruction set. The branch instruction in FIG. 4 is comprised of a 6 bit operation code (op) field 121, a 4 bit suboperation code (ext) field 123, a 6 bit register No. (Rm) field 122, a 6 bit register No. (Rn) field 124, a 1 bit branch prediction bit (I) 125, a 3 bit branch buffer (c) 126, and a 4 bit spare field (rsv) 127. The instruction in FIG. 5 is a PC branch instruction and the 16 bits of bit 10 through bit 25 constitute the displacement (s) field 128.

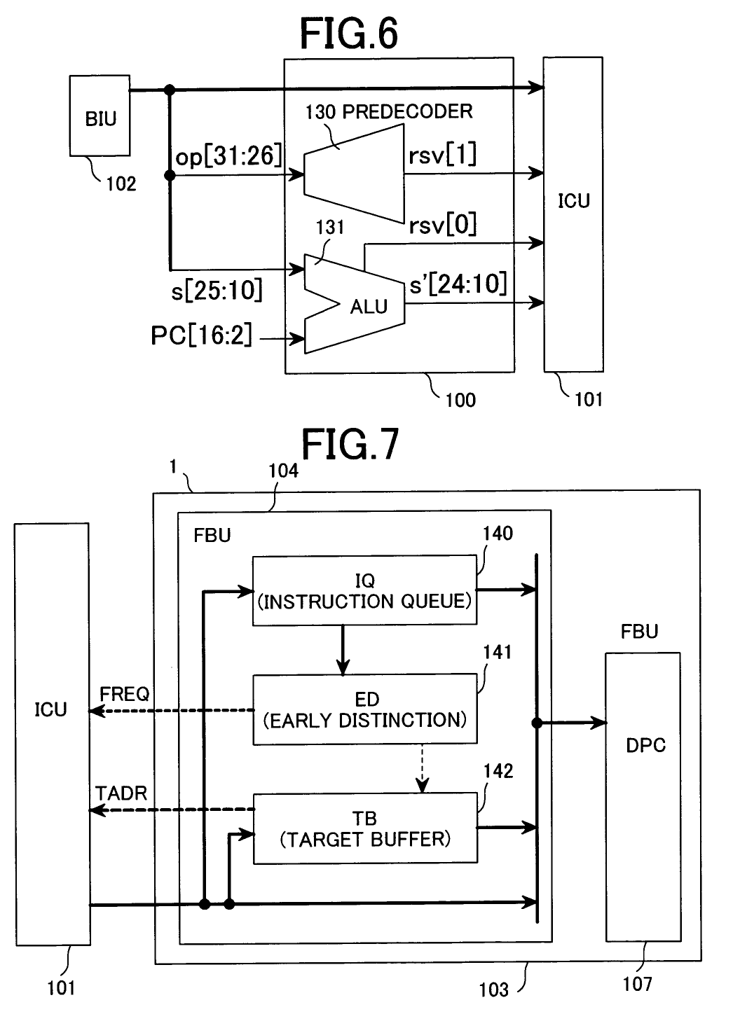

The predecode-processor (PD) 100 is shown in FIG. 6. The predecode-processor (PD) 100 is comprised of a predecoder 130 and an arithmetic logic unit (ALU) 131. The predecoder 130 decodes the operation code (op), matches those results to the spare field (rsv[1]) and supplies them to the instruction cache memory 101. The arithmetic logic unit (ALU) 131 adds the lower-ranking 16 bits of the PC to the displacement field value, matches the addition results to the displacement field, supplies them to the instruction cache memory 101, matches the carry to the spare field (rsv[0]) and supplies it to the instruction cache memory 101. In this example, when the results decoded by the predecoder 130 are a specified instruction such as a PC branch instruction, then the predecoder 130 rewrites the displacement according to the addition results output from the arithmetic logic unit (ALU) 131.

The operation of the predecode-processor (PD) 100 according to the second aspect of the function expansion is explained next. The branch instruction loaded from the external memory 106 is supplied to the predecode-processor (PD) 100 from the BIU102. The operation code op121 is decoded by the predecoder 130 inside the predecode processor (PD) 100 and a decision made only whether this instruction is a branch instruction or not. If it decides that the instruction is a branch instruction then a “1” is set in the output rsv[1] of predecoder 130 so this instruction can be identified as a branch instruction. The output rsv[1]=“1” is then stored in a field in the instruction cache memory 101 corresponding to the spare field 127 of the applicable instruction. Only a branch instruction was selected in the example given here, however the selection is not limited to branch instructions and the designer can select an instruction as needed.

The operation of the predecode-processor (PD) 100 according to the first aspect of the function expansion is explained next. In the case of a PC branch instruction with displacement as shown in FIG. 5, the ALU 131 adds the n bit address lower information (PC[16:2]) of the program counter to the displacement s[25:10] of the field; holds the n-bit addition results s' [24:10] in the area of the instruction cache memory corresponding to field 128 of the applicable program counter branch instruction with displacement; and the carry information from the addition is held in the area corresponding to the spare field (rsv[0]) of the applicable program counter branch instruction with displacement. The PC branch here is a branch instruction used as a reference for PC values during prefetch to the instruction cache memory. This prefetch is performed at a timing specified by the program and not at an optional timing for the open bus.

In the examples in FIG. 4 and FIG. 5, the spare field rsv for the instruction code is 4 bits so multiple information consisting for example of placement of simultaneous information such as selection only of branch instruction, and a digit-raising signal after calculating the branch destination address, can be stored in the cache area corresponding to the spare field sv127.

<Using the Second Aspect of Function Expansion>

The instruction flow unit 103 of FIG. 1 is comprised of a fetch-branch unit (FBU) 104 for controlling the instruction fetch and branch and a decode pipeline controller (DPC) 107 for performing instruction decoding and pipeline control. The instruction fetch operation is started by issuing a fetch request (FREQ) (See FIG. 7.) to the instruction cache 101 from the fetch-branch unit (FBU) 104 inside the instruction flow unit 103.

A more detailed drawing of the fetch-branch unit (FBU) 104 is shown in FIG. 7. The fetch-branch unit (FBU) 104 is made up of an instruction queue (IQ) 140 as a queuing buffer, an early distinction circuit (ED) 141, and a target buffer 142. The instruction queue (IQ) 140 temporarily holds instructions loaded from the instruction cache memory 101 in response to instruction fetch requests. The instruction held in the instruction queue (IQ) 140 is supplied to the decode-pipeline controller (DPC) 107 and decoded. The decoding sequence or in other words the loading (read-out) sequence from the instruction queue (IQ) 140 is controlled by the decode-pipeline controller (DPC) 107.

The early distinction circuit (ED) 141 determines the contents of the spare field of the instruction held in the instruction queue 140 and commands (instructs) the required procedure before instruction decoding by the decode-pipeline controller (DPC) 107. In other words, processing is implemented according to function expansion of the second aspect by executing the instruction fetched from the instruction cache memory. For example when determined to be a branch instruction, a request to fetch the instruction of the branched place(branch instruction) is made to the instruction cache memory 101. The early distinction circuit (ED) 141 uses the split-branch method. The split-branch method in other words is capable of separating (or splitting up) one branch operation into a branch preprocessing instruction (prepare target instruction) and branch processing instruction and then processing them. The branch preprocessing instruction commands the processing (or calculation) of the branch destination address and fetching of the instruction in the branch destination address. The branch processing instruction on the other hand commands the branch condition check and branch processing. The instruction in the branch destination address and branch address acquired from executing the branch preprocessing instruction are temporarily stored in the target buffer (TB) 142. When the early distinction circuit 141 determines at this time that the applicable instruction is a branch instruction by means of the spare field information for the instruction held in instruction queue 140, the loading of the instruction in the branch destination address and the following address of the branch destination address from the target buffer 142 is then commanded. Which means that, the branch commands could be processed by supplying to the decode-pipeline controller 107 an instruction in the branch destination address which is stored ahead of time in the target buffer 142, and by giving the following address TADR of the instruction to be executed at the branch destination to the instruction cache memory 101 from the target buffer 142.

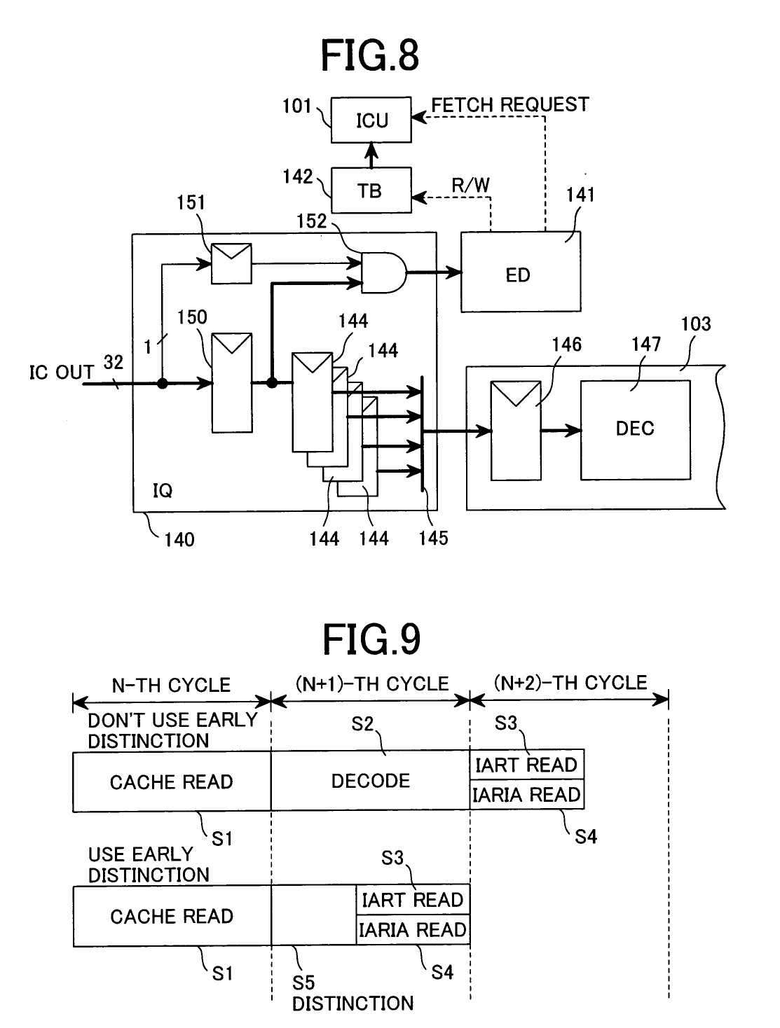

An instruction queue is shown in detail in FIG. 8. The instruction queue 140 for example has four memory stages 144 and the instruction for the memory stage selected by the selector 145 from the four memory stages 144 is supplied to the instruction flow unit 103 in a latter stage. The instruction flow unit 103 in this example contains an input latch 146 and instruction decoder 147. Memory stages 150, 151 for the early distinction circuit (ED) 141 are formed in the joint input stages of the memory stages 144. The memory stage 150 is comprised of a 32 bit flip-flop to hold the entire 32 bit instruction that was input. The memory stage 151 is comprised of a flip-flop to hold the one bit information rsv[1] corresponding to the spare field from among the instructions that were input. Each bit of memory stage 150 can be selectively supplied to the early distinction circuit 141 by way of the gate 152. The gate 152 is a two-input AND gate. One input of gate 152 is supplied with the output from memory stage 150. The other input of gate 152 is supplied jointly with the output from memory stage 151. When the instruction here is a branch instruction, the information rsv[1] for the spare field is set to a logic value “1” by the predecode-processor (PD) 100. This branch instruction is sent by way of gate 152 to the early distinction circuit (ED) 141 and priority-processed as described above without waiting for decoding at the decode stage by the instruction decoder 147.

FIG. 9 shows the operation timing when the early distinction circuit 141 is using the split-branch method. The target buffer 142 possesses the buffer IART for storing the branch instruction and the buffer IARIA for storing the next branch destination address to be executed next at the branch destination. The timing chart in FIG. 9 shows the operation timing for a three cycle portion made up of the n-th cycle, the n+1 cycle, and the n+2 cycle. When not using the early distinction circuit 141, and the fetch operation (S1) from the instruction cache memory has ended at an n-th cycle, then in the next cycle, the instruction decode processing (S2) is executed and the instruction identified. When decoding requires one cycle as shown in the figure, then in the next cycle, the buffer IART and IARIA loading (S3, S4) processing is performed in the n+2 cycle.

On the other hand, when the early distinction circuit 141 is used and the fetched instruction is a branch related instruction, the branch instruction information is stored inside the spare field so that after the fetch processing S1, the instruction decision processing S5 can be immediately performed at the start of the next cycle. The operation can therefore immediately shift to the S3, S4 processing to load the buffer IART, IARIA according to results of that S5 instruction decision process without waiting for instruction decoding by the instruction decoder.

<Using the First Aspect of Function Expansion>

To execute the instruction fetched from the instruction cache memory, the instruction decoder 147 processes the instruction destination address with the s′[24:10] displacement (immediate value) already calculated for the lower 16 bits of the instruction destination address when the rsv[0] equals 1. In other words, function expansion is executed according to the first aspect.

For example, when processing the branch destination address, the lower address is already calculated as a displacement of S′ [24:10] and can therefore be used as is (unchanged). Therefore only the upper 15 bits are needed for the calculation. The carry and the code area are already stored so that if the carry and code are both 0, or if the carry is 1 and the code is −1, then the PC[31:17] value is an effective address without needing any changes. Also, if the carry value is 0 and the code is −1, then the PC[31:17] value can be decremented by just a 1, and when the carry is 1 and the code is 0 then the PC[31:17] value may be incremented by just 1. Therefore, when a 32 bit +32 bit address must be calculated, the calculation can be completed by just incrementing or decrementing by 1 bit and the calculation of the branch destination instruction address can in this way be accelerated.

(Processing Instructions having No Spare Field)

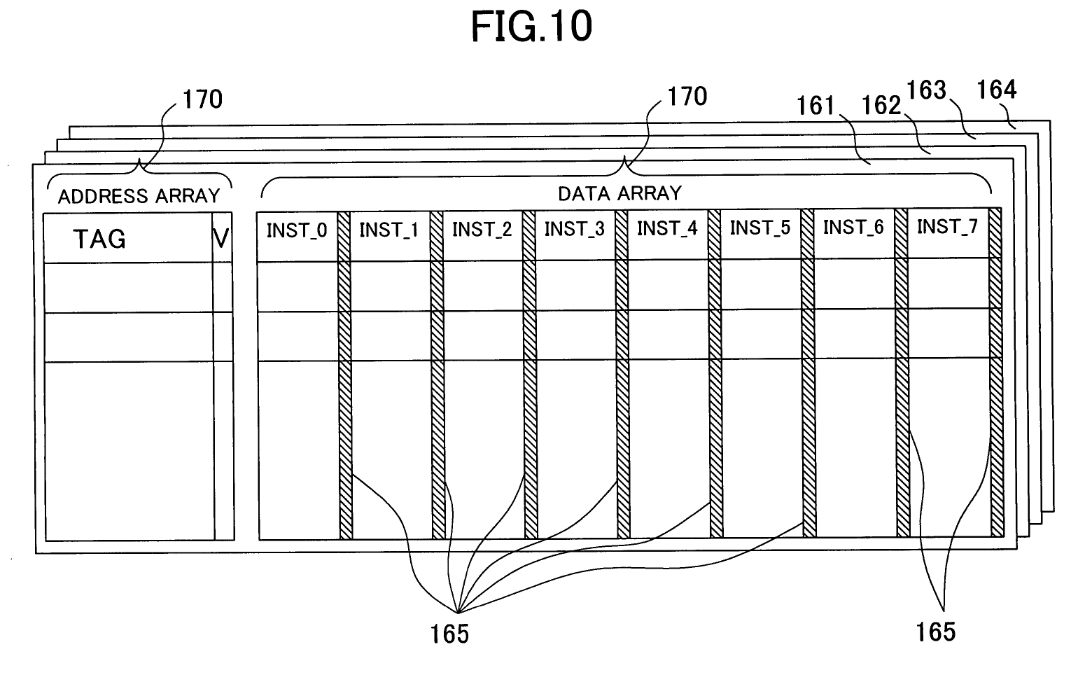

FIG. 10 shows an example of an instruction cache memory for instructions having no spare field. The instruction cache memory shown in this figure, has four ways 161 through 164 configured as a 4-way set associative group. Each way is made up of an address array 170 and a data array 171. A tag address (Tag) for that cache line and a varied bit (V) are stored in that address array 170. A joint index address for the eight instructions is stored in the data array 171. A storage area 165 for information generated based on the predecoding is appended behind the memory (storage) area of each instruction. By storing the decoding results for example of a branch instruction in the storage area 165, the instruction and its storage area 165 information are both loaded (read out) when the instruction is fetched, and that instruction can be identified as a branch instruction without having to await the end of instruction decoding. So the same effect can be obtained as when a spare field was used.

The present invention was described by utilizing a specific embodiment of the invention. However, the present invention is not limited to this embodiment and needless to say changes of all types can be made without departing from the spirit and the scope of the invention.

The examples in FIG. 4 and FIG. 5 for example showed an instruction code having a spare field however changes may be made as needed without being limited to these examples. The instruction length also is not limited to 32 bits and may be 64 bits, etc. The spare field may be considered a reserve field or an open field. The predecoder is not limited to identifying branch instructions and may for example be used just to sort instruction groups. The predecoder may also be used to identify other instructions.

The effect typically obtained from the invention as disclosed in these specifications is simply described as follows.

The present invention can in other words utilize a spare field to temporarily store information of various types in that field, and based on that information can decode the specified desired instruction at high speed. The branch processing can for example be executed at an early stage to improve performance. Therefore no problems in software compatibility occur, instruction processing time is shortened and a data processing device with high speed operation can be achieved.

What is claimed is:

1. A data processing device, capable of decoding and executing instructions, comprising:
a cache memory where said instructions are held, wherein said instructions each contain a spare field, and
wherein said cache memory holds information which is generated according to predecoding of instructions in a first corresponding area corresponding to said spare field.

2. The data processing device according to claim 1, further comprising:
controlling means which controls an executing sequence of said instructions based on information of said spare field, when executing instructions loaded from said cache memory.

3. The data processing device according to claim 2, further comprising:
a predecoder which predecodes said instructions to generate said information before instructions are stored into said cache memory.

4. The data processing device according to claim 3, wherein said predecoder decodes operation codes contained in first fields of said instructions.

5. The data processing device according to claim 4,
wherein information on a type of instruction obtained from decoding results from said predecoder is held in said first corresponding area of said cache memory.

6. The data processing device according to claim 5,
wherein said type of instruction includes an information of whether said instruction is a branch instruction or not.

7. The data processing device according to claim 6,
wherein said controlling means commands fetching an instruction of a branched place, when it determines that said instruction is a branch instruction according to said information in said first corresponding area of said cache memory.

8. The data processing device according to claim 7, further comprising:
a queuing buffer temporarily storing instructions loaded from said instruction cache memory; and
a target buffer which holds an address of said branched place, said instruction of said branched place, and a following address of said address of said branched place,
wherein said controlling means divides one branch operation into a prepare target instruction and a branch procedure instruction,
wherein said prepare target instruction commands the calculations of said address of said branched place and fetching of said instruction of said branched place,
wherein said branch procedure instruction commands branch condition checks and branch procedures.

9. The data processing device according to claim 8,
wherein said controlling means issues commands to load said instruction of said branched place and said following address from said target buffer when said controlling means determines that said instruction is a branch procedure instruction according to said information of said queuing buffer which was loaded from first corresponding area of said cache memory.

10. The data processing device according to claim 3, further comprising:
a processor performing calculations using information contained in first fields of said instructions before storing said instructions in said cache memory.

11. The data processing device according to claim 10,
wherein based on said decoding results, said cache memory holds calculation results from said processor in a second corresponding area of said instruction cache memory corresponding to said first fields.

12. The data processing device according to claim 10,
wherein to handle relative branch instructions of program counters with n bit displacements, said processor adds information of n lower bits of addresses of said program counters for displacements of said first fields in an adding operation, and
wherein added results by said processor are held in said second corresponding area of said cache memory, and
wherein carry information of said adding operation is held in said first corresponding area.

13. A data processing device, capable of decoding and executing instructions, comprising:
a cache memory where said instructions are held; and
a predecoder which performs predecoding of said instructions before said instructions are stored in said cache memory,
wherein said cache memory holds information generated by said predecoding of said instructions in an area which has a one to one relation with said instructions.

14. The data processing device according to claim 13, further comprising:
controlling means which controls an executing sequence of said instructions based on said information, when executing instructions are loaded from said cache memory.

15. The data processing device according to claim 14,
wherein said area is an area corresponding to a spare field of an instruction.

16. A data processing device, capable of decoding and executing instructions, comprising:
a cache memory; and
a predecoder,
wherein when an instruction is loaded, information generated from predecoding an instruction code of said instruction by said predecoder is written to a first area in said cache memory, and
wherein said first area corresponds to a spare field of said instruction code.

17. The data processing device according to claim 16, further comprising:
a bus interface unit controlling input and output of data,
wherein said instruction is loaded from an external memory through said bus interface circuit to said cache memory, and
wherein data from said bus interface unit to said cache memory flows through said predecoder for preceding.

18. The data processing device according to claim 17,
wherein when said data processing device executes instructions loaded from said cache memory, said information stored in said first area is used.

19. The data processing device according to claim 18,
wherein said information stored in said first area includes an information on branching.

20. The data processing device according to claim 19, further comprising:
a floating point operation unit; and
a data cache memory.
